(19) United States
(12) Patent Application Publication
(10) Pub. No.: US 2004/0006704 A1
(43) Pub. Date: Jan. 8, 2004

(54) System and method for determining security vulnerabilities

(76) Inventors: Dale A. Dahlstrom, San Antonio, TX (US); Keith P. Frederick, San Antonio, TX (US)

Correspondence Address: Jonathan L. Pettit, Brobeck Phleger & Harrison, LLP, 12390 El Camino Real, San Diego, CA, 92130, US

(21) Appl. No.: 10/189,164

(22) Filed: Jul. 2, 2002

(51) Int. Cl. G06F 11/30

(52) U.S. Cl. 713/200

(57) ABSTRACT

A method for determining security vulnerabilities includes receiving a profile of one or more products used by an organization, the profile including characteristics of each product. The method further includes comparing the characteristics of each product to a plurality of product records, each product record including one or more security vulnerabilities associated with the product record and one or more fixes associated with each security vulnerability. The method further includes determining at least one of the one or more security vulnerabilities for at least one of the one or more products in response to comparing the characteristics of the at least one of the one or more products to the product record.

### TECHNICAL FIELD OF THE INVENTION

This invention relates in general to the field of information technology, and more particularly to a system and method for determining security vulnerabilities.

### BACKGROUND OF THE INVENTION

Each year organizations throughout the world rely ever more heavily on the use of sophisticated hardware and software products to implement their core business processes. As a result, the number of such products utilized by such organizations has increased exponentially. Such increased reliance and the associated increase in product numbers means organizations are becoming more susceptible to significant disruptions in business caused by the potential exploitation of security vulnerabilities within such products.

However, despite being more susceptible to security vulnerabilities and having knowledge of the potential and significant consequences of exploitation, organizations are perhaps less prepared than ever to monitor and prevent security vulnerabilities. This is due to both the shear volume of products and the rate at which new products are introduced and/or existing products modified. Adding to the difficulty of such monitoring and prevention, organizations have also become much more distributed geographically, resulting in a corresponding distribution of employees and the products to support them.

While sources of information regarding potential security vulnerabilities have become more widely available, organizations do not have the time or resources to even initially search hundreds of information, developer, and manufacturer websites and databases for each product employed by the organization, much less time and resources to update such a search from time to time. More importantly, organizations do not have an effective tool for monitoring the progress of their organization towards addressing those security vulnerabilities that are identified.

### SUMMARY OF THE INVENTION

In accordance with the present invention, a system and method for determining security vulnerabilities is disclosed that has substantial advantages over previous systems and methods of determining security vulnerabilities.

In one embodiment of the present invention, a method for determining security vulnerabilities is disclosed that includes receiving a profile of one or more products used by an organization, the profile including characteristics of each product. The method further includes comparing the characteristics of each product to a plurality of product records, each product record including one or more security vulnerabilities associated with the product record and one or more fixes associated with each security vulnerability. The method further includes determining at least one security vulnerability of the one or more security vulnerabilities for at least one of the one or more products in response to comparing the characteristics of the at least one of the one or more products to the product record.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is one embodiment of a system for determining security vulnerabilities implemented according to the teachings of the present invention;

FIG. 2 is one embodiment of a computer used to implement various components of the system of FIG. 1;

FIG. 3 is one embodiment of a product record implemented according to the teachings of the present invention;

FIG. 4 is one embodiment of an organization profile implemented according to the teachings of the present invention;

FIG. 5 is one embodiment of a method for determining security vulnerabilities implemented according to the teachings of the present invention;

FIG. 6 is one embodiment of a tracking form implemented according to the teachings of the present invention;

FIG. 7 is one embodiment of a security solutions assessment module used with various components of the system of FIG. 1 and implemented according to the teachings of the present invention;

FIG. 8 is one embodiment of a process for selecting a security solution implemented according to the teachings of the present invention;

FIG. 9 is one embodiment of a process for determining a risk rating implemented according to the teachings of the present invention; and

FIG. 10 is one embodiment of a report generated by a tracking system according to the teachings of the present invention.

### DETAILED DESCRIPTION OF THE INVENTION

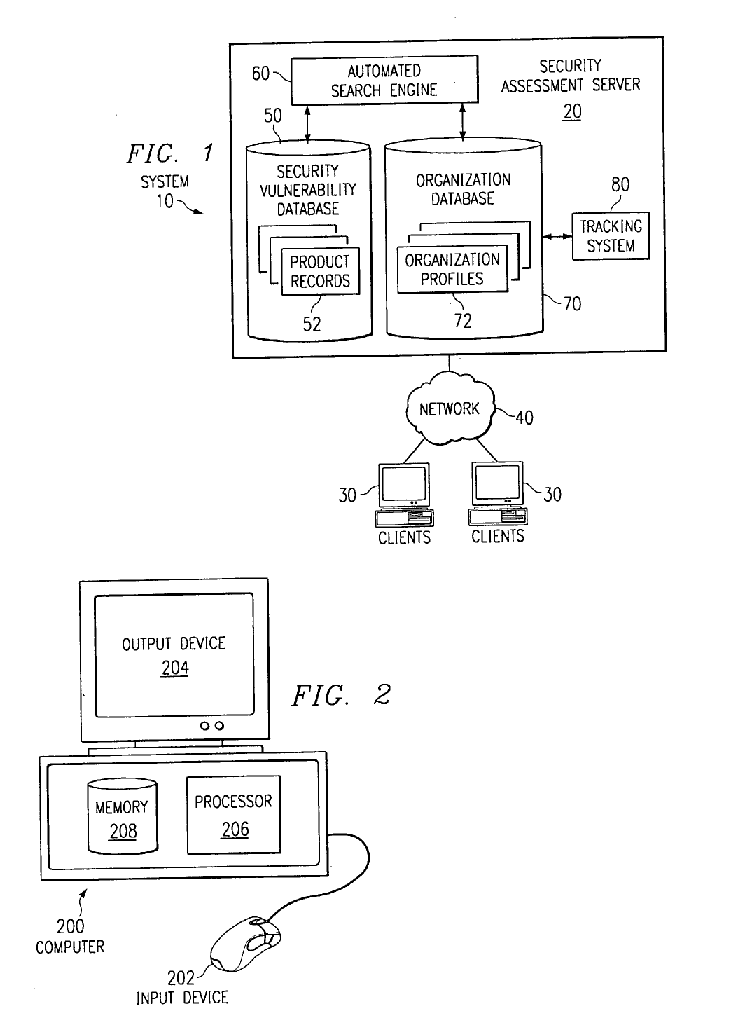

FIG. 1 illustrates one embodiment of a system 10 for determining security vulnerabilities of electronic devices and recommending corrective actions to be taken to respond to such security vulnerabilities. Security vulnerabilities may be forms of vulnerability to third party intrusion into, interference with, sabotage of, or monitoring of an electronic device or network of electronic devices. More generally, for purposes of this application, security vulnerabilities may also be vulnerabilities to any circumstance an organization wishes to avoid as part of the practices and standards they adopt regarding the installation and use of the organization's hardware and software products. Hereafter, security vulnerabilities may also be referred to as vulnerabilities.

The system 10 also allows a user to track the implementation of such corrective actions to address vulnerabilities across a group of electronic devices, such as, for example, those electronic devices forming a computing network or portion thereof. In such a manner, large corporations may utilize the system 10 to keep track of security vulnerabilities in each of the thousands of electronic devices used by such corporations to transact business on a daily basis. For example, a system administrator may utilize the tracking tools of the system 10 to objectively assess a communication network's vulnerability to security risks and monitor the progress of information technology personnel in responding to new security risks.

In the illustrated embodiment, the system 10 includes a security assessment server 20 in communication with a plurality of clients 30 across a network 40. The system 10 may alternatively be a stand-alone computer.

In the illustrated embodiment, the clients 30 are personal computers; alternatively, however, a particular client 30 may be a workstation, terminal, web appliance, personal digital assistant, cellular telephone, pager or any other suitable computing device having input and output modules that enable a user to enter and view data. A particular client 30 may include a web browser or other interface software and/or hardware, volatile and/or nonvolatile memory, processor and/or other processing components, and/or other software, hardware, and peripherals suitable for such a computing device.

As discussed, the clients 30 may maintain and execute browsers or other suitable parsing programs for accessing and communicating information addressed by Uniform Resource Locators (URLs). Any suitable communications protocol may be implemented in combination with one or more generally available security and/or encryption techniques to ensure the secure, private communication of data between the server 20 and the clients 30.

In the illustrated embodiment, the network 40 is a virtual private network operating on the Internet using suitable security protocols. Alternatively, the network 40 may be any form of a private and/or public network using dedicated and/or switched communication paths. For example, the network 40 may be implemented using a combination of one or more wireless, fiber, cable, or twisted-pair connections over the Internet, a public-switched telephone network, a satellite, radio, microwave, other wireless link, and/or any other suitable communications links between the components of system 10.

In the illustrated embodiment, the security assessment server 20 includes a security vulnerability database 50, an automated search engine 60, an organization database 70, and a tracking system 80. In the illustrated embodiment, the security vulnerability database 50 is an Oracle database; however, any other suitable database may be utilized. The database 50 includes a plurality of product records 52 categorized and indexed using product categories, product vendors, and/or product names, each product record 52 being associated with a computing, networking, or communications hardware or software product.

Each product record 52 includes vulnerability data associated with known security vulnerabilities faced by the product associated with such product record 52 as well as known fixes to be taken to address such security vulnerability. For purposes of this application, a fix is one or more patches, updates, tweaks, procedures, preventative actions, configuration changes, work-arounds, suggestions of alternative products to be used, and/or any other suitable recommendations to prevent, reduce the risk of, or avoid particular circumstances associated with a security vulnerability.

However, often a product name is not enough information to determine whether security vulnerabilities exist for a particular product. Thus, each product record 52 will have sufficient granularity to also include more detailed product data for the particular product associated with such product record 52 such as model number, product series, product version number, product operating system, software patch, software service pack, and/or any other suitable information that may be relevant to determine both whether an actual specific vulnerability may exist for a particular product and the best fix available to address such vulnerability.

In such a manner, each product record 52, for example, may identify security vulnerabilities and available fixes for a particular product version, with or without a particular patch or service pack being installed, and regardless of the hardware and/or software platform the product utilizes. An embodiment of a particular product record 52 is illustrated in FIG. 3. Each product record 52 may be manually or automatically updated from time to time by a user, an automated update engine similar to that used in the Windows operating system, a web spider, or any other suitable manner capable of searching Internet or other resources associated with security vulnerability detection or individual product and manufacturer web sites.

In the illustrated embodiment, the automated search engine 60 is a combination of two software components. The first component is a query driven search engine included, for example, with software packages accompanying databases such as those distributed by Oracle. The second component is a set of scripts designed to copy data from different fields of an organization profile 72 stored in the organization database 70 into a search pattern used by the query driven search engine to execute a search of security vulnerability database 50. The automated search engine 60 may also include additional scripts having additional functionality. For example, scripts may be utilized to filter the data copied from a particular organization profile 72 and/or filter results from a search of the security vulnerability database 50. More particularly, a script filter may be utilized to modify the results of a search based on relationships between products identified in the particular organization profile 72. In such a manner, a user of system 10 may avoid receiving inapplicable or duplicative information on security vulnerabilities.

In the illustrated embodiment, the organization database 70 is an Oracle database similar to that utilized for the security vulnerability database 50; however, any other suitable database may be utilized. The organization database 70 includes a plurality of organization profiles 72, each associated with a particular organization using the system 10 to assess security vulnerabilities and track the organization's response to indicated security vulnerabilities. Each organization profile 72 may include an organization profile, contact information, login information for authorized users within the organization, and a list of hardware and software products used by the organization. Each organization profile 72 may be completed by a user via a particular client 30, a network mapper, a device scanner, menu structures, directory listings, and/or any other suitable data source or product listing. In such a manner, portions of each organization profile 72 may be filled out manually, automatically, or any combination thereof.

The list of hardware and software products included within each organization profile 72 may be organized in a multi-tiered manner and further broken down by product category, the department of the organization maintaining or using the products, or any other suitable category. Similar to the security vulnerability database 50, each product item in the list of software and hardware products within each organization profile 72 will have fields of associated product data such as product name, product category, product vendor, model number, product series, product version number, product operating system, software patch, software service pack, and/or any other suitable information that may be relevant to determine whether an actual specific vulnerability may exist for each product item. All of the fields should preferably contain accurate and timely data associated with the listed product item as it is currently implemented and used within the organization.

The organization profile 72 may also include tracking information regarding each product and any determined security vulnerabilities for such product. Such tracking information may include the existence of any unresolved security vulnerability, the current progress of the organization towards correcting a security vulnerability, and metrics associated with those security vulnerabilities that have been corrected such as completion time, for example. Tracking information may also include more general information regarding the organization as a whole, or any portion thereof. Such tracking information is determined by the tracking system 80 as further described below. An embodiment of the organization profile 72 is further illustrated in FIG. 4.

In the illustrated embodiment, the tracking system 80 is a statistical software application used by the security assessment server 20 to track the progress of an organization towards addressing security vulnerabilities. In particular, as discussed above, each organization profile 72 may have subsets of product items associated with different segments of an organization. Responsibility for preventing security vulnerabilities may be distributed across many individuals within an organization. For example, information technology professionals may have a scope of responsibility for preventing security vulnerabilities based on geographic location, facility, product type, or any other suitable criteria. The tracking system 80 handles updating tracking information for the organization profiles 72 by analyzing progress such responsible individuals have made towards resolving a security vulnerability. The tracking system 80 retrieves tracking information on each product within an organization and calculates such data as the number of security vulnerabilities identified, the number of such security vulnerabilities addressed by responsible individuals, the timeliness of such security vulnerabilities being addressed, or any other suitable data points.

In the illustrated embodiment, various components of the system 10 are implemented in a programming environment that supports access or linking to various sources of information using URL addresses. As such, the content of such modules and databases may be constructed using Hypertext Mark-Up Language (HTML), Extensible Mark-Up Language (XML), other forms of Standard Generalized Mark-Up Language (SGML), Virtual Reality Mark-Up Language (VRML), Javascript, or any other appropriate content development language. The modules of the system 10 may also include program code, such as applets or servlets written in Java, or other appropriate self-executing code.

Although various components of the system 10 are illustrated in this FIG. 1 as separate components, the components of the system 10 may be implemented using a single processor such that the single processor accesses stored algorithms, executables, and other data that are stored in read-only memory, for example, and executed using random access memory. Likewise, any databases, modules, subsystems and other illustrated may be combined, separated or distributed across one or more processing and/or memory devices. Memory for such databases, modules, subsystems, or other components of the system 10 may be implemented using one or more files, data structures, lists, or other arrangements of information stored in one or more components of random access memory, read-only memory, magnetic computer disks, compact disks, other magnetic or optical storage media, or any other volatile or nonvolatile memory.

Likewise, it should be understood that any components of the system 10 may be internal or external to the illustrated components of the system 10, depending on the particular implementation. Also, databases, modules, subsystems or other components of the system 10 may be separate or integral to other components. Any appropriate referencing, indexing, or addressing information can be used to relate back to an address or location of a database, file or object within the system 10.

The operation of system 10 is described in FIGS. 3 through 10. However, in general, the security vulnerability database 50 is accessed by the automated search engine 60 in response to an organization completing and submitting a particular organization profile 72 to organization database 70. Such organization profile 72 includes selections of computing, networking, and telephony hardware and software products used by the organization. By searching the security vulnerability database 50, the automated search engine 60 identifies vulnerabilities associated with the company's selected products. As an organization will indicate the product data described above for each of its selected products, the automated search engine 60 will determine vulnerabilities specific to the exact product data indicated by the organization. Once determined, the automated search engine 60 may determine and recommend fixes for each of such detected vulnerabilities.

The automated search engine 60 may also correlate results of such a search by comparing vulnerabilities associated with more than one product. For example, the automated search engine 60 may discard multiple fixes for vulnerabilities associated with multiple products when the implementation of one fix makes other fixes redundant. Provided the information is available, the automated search engine 60 may also be configured to determine when one vulnerability associated with a first product is eliminated by a company's use of a second product. The automated search engine 60 may also be configured to determine when a company's use of a first product with a second product creates a vulnerability that may not exist with either of the products individually.

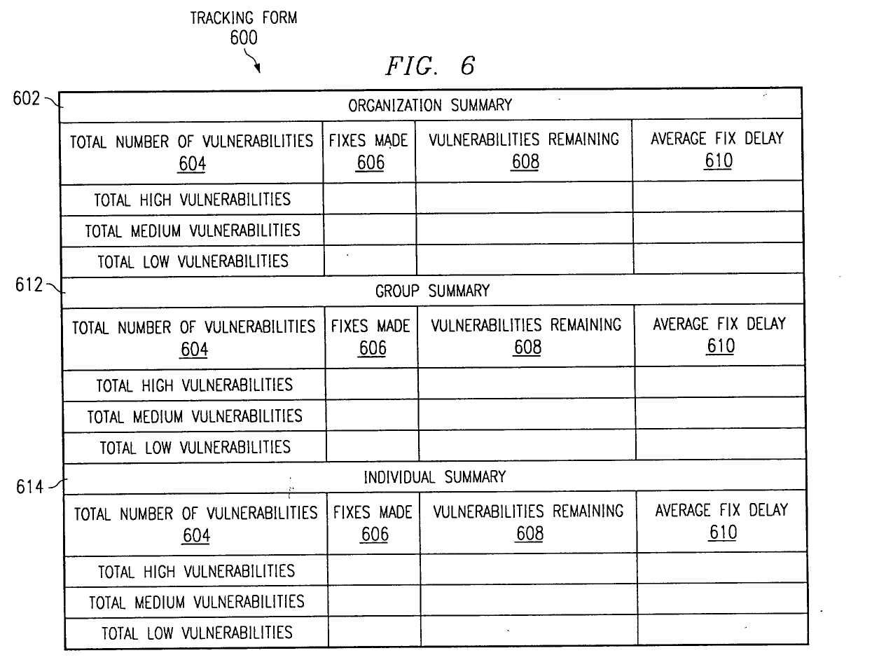

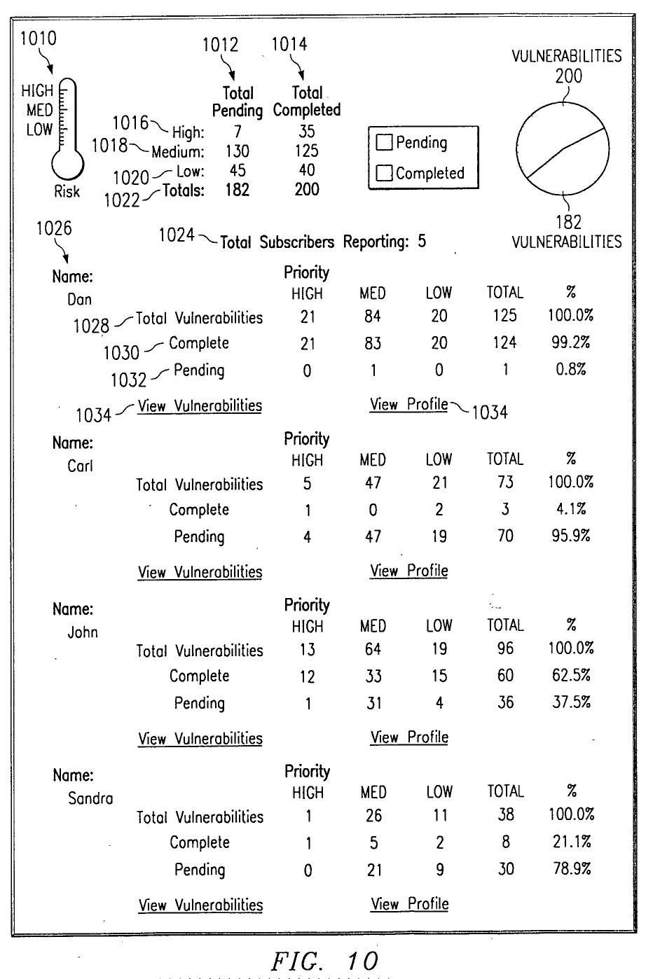

The automated search engine 60 can also retrieve risk ratings associated with risk assessments for each vulnerability that are based on a combination of factors including the severity of the vulnerability, the likelihood of the vulnerability being exploited, the ease of the vulnerability being exploited, how well-known the vulnerability is, and any other suitable information on the vulnerability, its impact, and/or how it may be exploited. One embodiment of how such a risk rating is determined is described with respect to FIG. 9. Such risk ratings may be inserted and represented in an organization's organization profile 72 using a graphical or text object indicative of the determined level of severity. Such risk ratings also play an integral role in the operation of server 20 as a risk management tool. Using metrics and statistical information calculated by the tracking system 80 and risk ratings indicated by automated search engine 60, a broad array of reporting options are available to an organization as further described in FIG. 6.

Now referring to FIG. 2, in one embodiment, components of system 10 may operate on one or more computers 200. Each computer 200 includes one or more input devices 202 such as a keypad, touch screen, mouse, or other pointer or device that can accept information. Each computer 200 also includes one or more output devices 204, such as a monitor, for example, that conveys information associated with the operation of system 10 such as digital data, visual information, and/or audio information. Each computer 200 also includes processor 206 and its associated memory 208 that execute instructions and manipulate information in accordance with the operation of system 10. For example, processor 206 may execute coded instructions that are stored in memory 208 on data that is also stored on memory 208. Each computer 200 may also include fixed or movable storage media such as a magnetic computer disk, CD-ROM, or other suitable media to either receive output from, or provide input to, components of system 10.

Now referring to FIG. 3, an embodiment of a particular product record 52 used to store known vulnerability information about an associated product configuration is illustrated. The product record 52 includes a product category 302, a vendor 304, a product name 306, a product model or series number 308, a product version number 310, a product operating system 312, one or more software patches 314, and one or more software service packs 316. The product record 52 also includes vulnerabilities 318 V1 through V3 known to exist for the associated product configuration, risk ratings 319 R1 through R3 corresponding to each of such vulnerabilities 318, and fix recommendations 320 F1 through F3 corresponding to each of such vulnerabilities 318. Alternative embodiments of the product records 52 may include any suitable information that may be relevant to determine both whether an actual specific vulnerability may exist for a particular product configuration and the best fix available to address such vulnerability.

Now referring to FIG. 4, an embodiment of portions of a particular organization profile 72 are illustrated. The particular organization profile 72 includes an organization name 402, contact information 404, summary tracking information 406, and one or more product lists 408 of hardware and software products used by the organization. Each product list 408 may be a list of all products for the organization as a whole or a list of a subset of products selected and/or categorized according to product type, vendor, individuals, departments of the organization, or according to what individual or group within the organization has responsibility for monitoring security vulnerabilities on such products.

Each product of the product list 408 includes fields of associated product data such as a product name 410, a product category 412, a product vendor 414, a model or product series number 416, a product version number 418, a product operating system 420, a software patch 422, a software service pack 424, and/or any other suitable information that may be relevant to determine whether an actual specific vulnerability may exist for each product item. Some products may not have any relevant data to be placed into one or more of such fields. For example, a product may not run on an operating system. Each product of the product list 408 may also include additional product tracking information 426 associated with security vulnerabilities and any fixes thereto made by the organization. Additional fields for each product may include the identification of each determined security vulnerability 428, a corresponding risk rating 430 for each of such security vulnerabilities 428 as further described in FIG. 9, a status 432 of each of such security vulnerabilities 428, the determination date 434 on which each security vulnerability 428 was identified, a fix 436 corresponding to each of such security vulnerabilities 428, an indication and verification 438 that each such fix 436 was implemented, a fix date 440 for each such indication and verification, if any, and/or a fix duration 442, if applicable, associated with the time it took an organization, group, or individual to address a vulnerability once it was determined. =p Tracking information fields 408 and 426 may include overall summaries of vulnerability tracking within the organization or with respect to a particular product. Such tracking information fields 408 and 426 may also include statistical information such as means, medians, ranges, and deviations derived by tracking system 80.

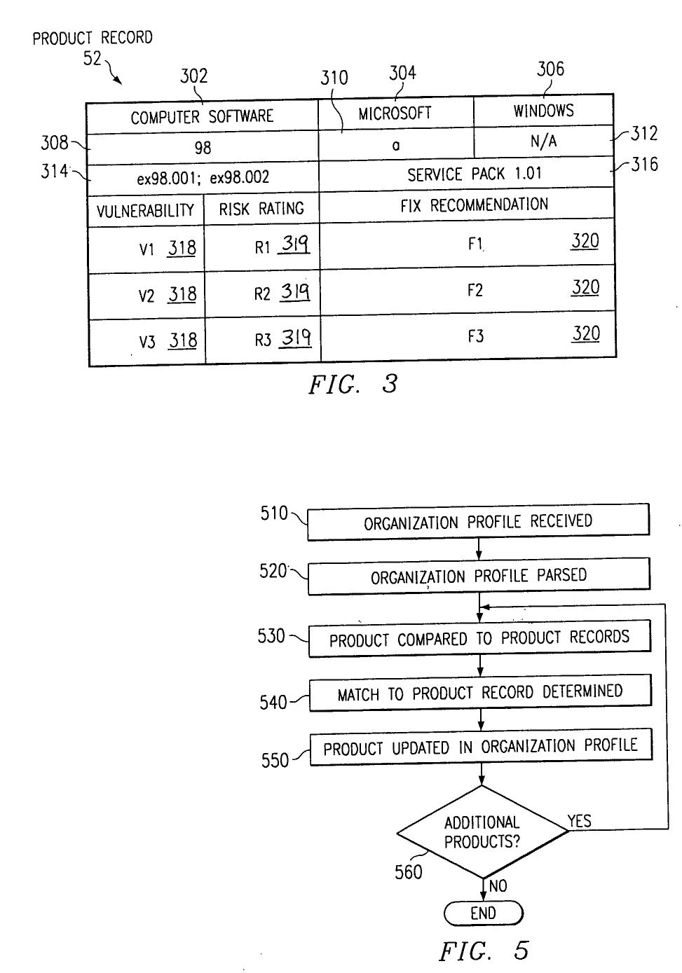

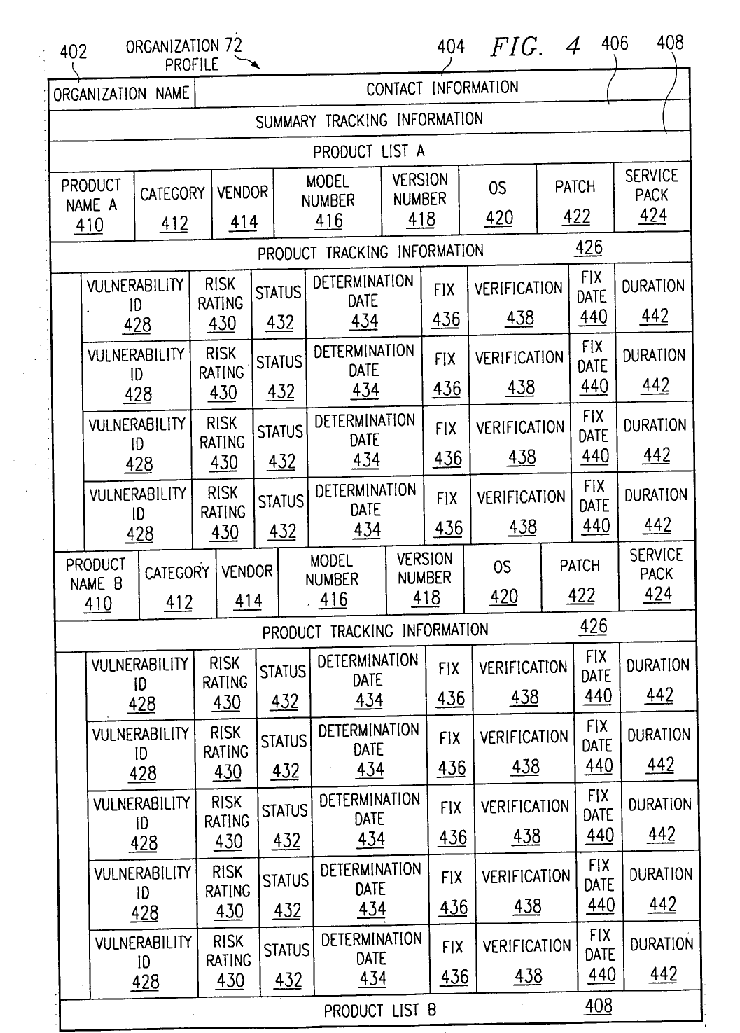

In FIG. 5, a process for determining security vulnerabilities is illustrated. In step 510, a particular organization profile 72 is received. In step 520, the particular organization profile 72 is parsed by the automated search engine 60 to generate a list of the products used by the organization that is characterized using the associated product information for each product described in FIG. 4.

In step 530, the first product in the parsed list is compared to each of the product records 52 by the automated search engine 60 matching the associated product information to the fields of product data included within each of the product records 52. For example, the version number and installed patches indicated in the particular organization profile 72 relative to the first product may be matched up with corresponding fields of a particular product record 52 in the security vulnerability database 50 in order to identify applicable security vulnerabilities present in the first product given its current configuration.

Although product records 52 are illustrated and described throughout this application as a product record including information regarding a particular product configuration and associated vulnerabilities, the designation product records 52 as used herein may instead be vulnerability records including information regarding particular vulnerabilities, one or more associated fixes for each, and particular product configurations likely to be impacted by such vulnerabilities. In such an alternative embodiment, in step 530, the first product in the parsed list is compared to each of the indicated particular product configurations within each vulnerability record to determine which vulnerabilities the product may be susceptible to and an appropriate fix therefor.

In step 540, a match between the first product and one of product records 52 is determined based on the comparison described in step 530. In step 550, each product included in the product list 408 of the particular organization profile 72 determined to have a match within security vulnerability database 50 is updated with the security vulnerabilities 318, their associated risk ratings 319, and their associated fixes 320 from the matched product record 52. Such information is copied as one or more vulnerability identifications 428, risk ratings 430, and fixes 436 for the particular product within particular organization profile 72.

In step 560, the system 10 determines if there are any additional products in the parsed product list. If there are no additional products, the initial determination of security vulnerabilities for the organization is complete. The same process of determination may be made subsequent to the initial determination at any time upon the request of the organization or automatically by system 10 at regular intervals designated by the organization, any time new products are entered into any of product lists 408, or any time security vulnerability database 50 is updated. In such a manner, the organization profile 72 for the particular organization may be a dynamic document and reporting tool reflective of the current state of both the organization and the current state of security vulnerabilities in the marketplace.

If the system 10 determines in step 560 that there are additional products for which security vulnerabilities need to be identified, system 10 repeats steps 530 to 550. However, upon determining that a product from the parsed product list matches a particular product record 52 in step 540, and prior to copying security vulnerability information from such product record as one or more vulnerability identifications 428, risk ratings 430, and fixes 436 for the particular product, automated search engine 60 may perform additional filters and/or determinations. For example, automated search engine 60 may determine vulnerabilities that are: redundant or duplicative of those already determined and reported for previous products, resolved or otherwise not at risk because of the organization's use of another product within the parsed product list, and/or inapplicable because the organization has already acted upon a fix recommended by system 10 or otherwise. If no such determinations are made, all vulnerability information may be copied as described in step 550. If such determinations are made so as to eliminate a particular security vulnerability from consideration, such vulnerability may be not copied into the particular organization profile 72, may be copied with an annotation describing the determination, or may be copied but indicated as already fixed because of a previous action taken by the organization.

In FIG. 6, one embodiment of a tracking form 600 for displaying tracking information for a particular organization is illustrated. In such an embodiment, information relevant to the tracking of security vulnerabilities and their recommended fixes is presented in a form suitable for use by an organization for evaluating summary tracking information and statistical data derived therefrom.

The illustrated tracking form 600 includes example sections corresponding to an organization summary 602, a group summary 612, and an individual summary 614. Each of such summaries 602, 612, and 614 includes data associated with both the total vulnerabilities relevant to such summary and data associated with subsets of vulnerabilities classified according to a risk rating determined as described with reference to FIG. 9. More particularly, each summary 602, 612, or 614 includes data corresponding to a number of determined vulnerabilities 604, a number of fixes implemented to address such vulnerabilities 606, a number of vulnerabilities remaining 608, and the average fix delay 610 between vulnerabilities being detected and fixes being implemented. Other suitable data retrieved from the associated organization profile 72 and/or statistical information generated by tracking system 80 may also be included within each summary 602, 612, or 614.

As illustrated, such data is given not only for the organization, group, or individual as a whole but also for subsets of vulnerabilities broken down according to high, medium, and low risk categories as defined in FIG. 9, for example. In such a manner, management personnel within an organization can review the performance of the organization as a whole, or any portion thereof or individual working therefor, relative to implementing fixes and addressing vulnerabilities. For example, the information technology director of a company can monitor each department or individual under his or her control to evaluate their progress towards resolving vulnerabilities. Likewise, an employee may monitor his or her individual progress.

Furthermore, by assigning different levels of access to each employee of the organization, users may only be authorized to view certain summaries. For example, a low level employee may only have access to his or her individual summary 614 while a manager of a group may only have access to his or her group summary 612 and individual summaries 614 for each of the employees he or she supervises. Only higher level administrative personnel may have access to the organization summary 602, and perhaps even fewer personnel would have complete access to all summaries 602, 612, and 614 used throughout the organization.

In FIG. 7, a security solution analysis module 760 is illustrated in communication with the security assessment server 20 described in FIG. 1 and a purchasing system 770. The security solution analysis module 760 includes security product profiles 762 and security product reports 764.

The security product profiles 762 include information regarding and properties of publicly available products providing security solutions. For example, each security product profile 762 may include information for a particular security solution such as the intended use of the security solution, cost, ease of installation or ease of use, reporting capabilities, desired filtering capabilities and scripts, the availability of updates, and/or any other suitable criteria.

The security product reports 764 are forms generated by the security solution analysis module 760 to present and/or compare recommended security solutions to a user. The purchasing system 770 is an electronic ordering system that includes suitable forms and processes necessary to allow a user to electronically order a particular security solution and enter information associated with payment and delivery of such a security solution. Although illustrated as a separate component to the server 20, the security solution analysis module 760 and/or the purchasing system 770 may be included within the server 20 as an additional integral component.

In operation, the security solution analysis module 760 is a software application that may be linked to by a fix recommended by the automated search engine 60 within the server 20, launched as a result of a request by a user for a recommended security solution given the organization profile 72 associated with the user, or launched as a separate stand alone application unrelated to an organization profile or any recommended fixes.

In general, the security solution analysis module 760 compares and analyzes particular security products to support purchasing decisions of an organization. Such a comparison and analysis may be customized for a particular user or organization. For example, the security solution analysis module 760 may allow a user to indicate priorities with respect to qualities of a security solution and compare such priorities to the security product profiles 762 to generate a selection of options for a security solution in the security product reports 764. Alternatively, such priorities may be automatically generated based on a recommended fix or products included in a completed organization profile.

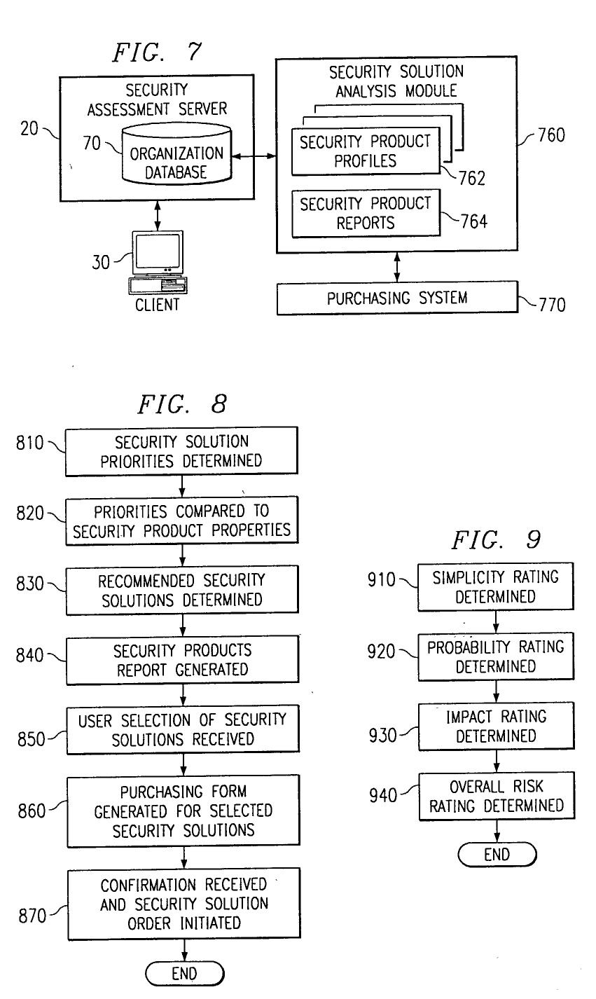

The security product reports 764 may include links to purchasing system 770 allowing a user to directly order one or more of the security solutions recommended in the security product reports 764. The purchasing system 770 allows a user to enter purchasing and shipping information and electronically order desired security solutions. Alternatively, purchasing and shipping information for an organization may be automatically populated into purchasing and shipping forms generated by the purchasing system 770 using the organization's associated organization profile 72. The operation of security solution analysis module 760 is further described with reference to FIG. 8.

FIG. 8 illustrates a process for recommending and/or purchasing a security solution for a particular organization. In step 810, security solution priorities are determined for a particular organization. Such priorities may be determined manually by a user or automatically in response to the products included within the organization profile 72 of the particular organization, vulnerabilities determined therein, or fix recommendations made therefor.

In step 820, such priorities are compared to properties of particular security solutions indicated in the security product profiles 762. Such a comparison may be an automatic process or may be done manually by a user. In step 830, recommended security solutions are determined for the organization in response to such comparison. Again, this can be done manually by a user or automatically by determining one or more suitable matches between the priorities determined and the properties of the security solutions. In step 840, a particular security product report 764 is generated indicating the security solutions that are suitable matches. Such particular security product report 764 may include summary information regarding the security solution as well as links to an order form for such security solution within the purchasing system 770.

In step 850, a user selection is received corresponding to the user selecting one or more of the suitable security solutions for purchase from the particular security product report 764. In step 860, a purchasing form is generated by the purchasing system 770 for the purchase of such security solution. Such a form may be manually completed electronically by an authorized representative of the particular organization or automatically populated with purchasing and shipping information using information entered in the associated organization database 70. In step 870, a user confirmation of the purchasing decision is received and an order fulfillment process is initiated by the purchasing system 770.

FIG. 9 illustrates a process for determining a risk assessment of a particular security vulnerability. More particularly, the process includes calculating a risk rating for a particular security vulnerability based on the simplicity of such security vulnerability being exploited, the popularity/probability of the security vulnerability being exploited, and the impact to an organization should a security vulnerability be exploited.

In step 910, a simplicity rating is determined. More particularly, a simplicity rating may be a numerical rating determined across a scale of numbers. For example, a simplicity rating may vary from a rating of one, corresponding to an exploitation of a security vulnerability that is very difficult, to a rating of five, an exploitation of a security vulnerability that is very easy. Such rating may be assigned to an exploitation based on the requirements an individual or organization would have to meet in order to implement an exploitation of the particular security vulnerability. For example, variables such as the degree of administration and coding skills required, the type of access to a device or network necessary to implement the exploitation, the types of details and information required to implement the exploitation, and whether external tools exist with which to exploit such vulnerability. The details and information required to exploit a security vulnerability may require a particular exploiter to be an insider familiar with the practices and procedures of the organization having the vulnerability.

In step 920, a popularity or probability rating is determined. Such popularity or probability rating shall be referred to in this application as a probability rating and may be a numerical rating similar to the simplicity rating described above. Such a rating may vary, for example, from a rating of one indicating that the likelihood of a exploitation is very remote, to a probability rating of five indicating that the likelihood of an exploitation is highly probable. Such probability rating may be determined based on how well known information is on the vulnerability, how widely used the product is having the vulnerability, and whether there are any current known instances of the vulnerability being exploited throughout the international community.

In step 930, an impact rating is determined to reflect the anticipated severity of the security vulnerability being exploited and/or the potential reward to a particular exploiter who successfully takes advantage of the security vulnerability. Such impact rating may also be a numerical rating assigned based on relevant factors.

For example, the impact rating for a particular security vulnerability may have an impact rating of one if the anticipated severity of the security vulnerability being exploited is insignificant, or may have an impact rating of five if the anticipated severity of a particular security vulnerability being exploited is critical.

Such numerical rating may be determined by looking at the access level granted to an exploiter taking advantage of the security vulnerability, the severity of potential damage to an organization's products or networks if such security vulnerability is exploited, the detectability of such exploitation and possible reaction time of the organization to such exploitation, the type of information accessible by an exploiter of such security vulnerability, and/or any other suitable factors relevant to accessing the severity in damage the exploitation of a particular security vulnerability may cause.

In step 940, an overall risk rating is determined that represents an overall priority being assigned to a particular security vulnerability. Such a risk rating may be used to evaluate an organization's overall susceptibility to security vulnerabilities, assign a prioritization to addressing each of an organization's security vulnerabilities, or otherwise making a comparison between all of the security vulnerabilities faced by a particular organization. Although such risk rating may be determined by any manner of combining and weighting each of the simplicity rating, probability rating, and impact rating, in one embodiment, such risk rating is on a similar numerical rating scale to each of the component ratings.

For example, a risk rating may be a numerical value ranging from one to five, with one corresponding to a relatively low risk rating and five corresponding to a relatively high risk rating. In such an embodiment, the risk rating may be calculated, for example, by multiplying the simplicity rating by 0.3, adding the result to the sum of the probability rating multiplied by 0.3, and adding that combined sum to the impact rating multiplied by 0.4. Such a calculation is represented by the following formula: Risk Rating=(Simplicity Rating×0.30)+(Probability Rating×0.30)+(Impact Rating×0.40).

In one embodiment, a risk rating is graphically illustrated using a risk thermometer with relative risk “temperatures” ranging from a temperature of one to a temperature of five identified by a bright red bar graph or other suitable graphical representation. Obviously, a risk rating may be presented across any number of suitable ranges, whether with numbers, words, graphical representations, letters indicative of severity, or any other suitable indications. For example, the risk ratings of “high”, “medium”, and “low” may be assigned to risk ratings numerically calculated over a range of one to five. In such an embodiment, for example, a “high” rating may be assigned to a numerical risk rating of 3.7 to 5, a “medium” rating to a numerical risk rating of 2.4 to 3.6, and a “low” to a numerical risk rating of 1.0 to 2.3.

Now referring to FIG. 10, an embodiment of a tracking report generated by the tracking system 80 is illustrated. The tracking report includes a risk thermometer 1010 with risk ratings of low, medium, and high. The tracking report further includes vulnerability tracking categories of 1012 and 1014, corresponding to pending vulnerabilities that have not been neutralized or otherwise addressed and completed vulnerabilities that have been neutralized or otherwise addressed, respectively. Each category 1012 and 1014 breaks down the number of vulnerabilities currently present within an enterprise, organization, or other set or subset of an entity's systems, networks, equipment, or devices (hereafter referred to as an organization for convenience) at risk for vulnerabilities based on risk ratings 1016, 1018, and 1020 determined, for example, as described in FIG. 9. In particular, the risk rating 1016 corresponds to a high risk rating. The risk rating 1018 corresponds to a medium risk rating. The risk rating 1020 corresponds to a low risk rating. In the tracking report, a vulnerability totals row 1022 illustrates the total number of pending and complete vulnerabilities tracked by the tracking system 80. A total subscribers reporting counter 1024 illustrates the number of individuals or subscribers, tracking vulnerabilities throughout the organization.

The tracking report also breaks down the overall vulnerabilities of an organization into vulnerabilities under the scope or direction of individuals or subscribers within the organization. For example, a total vulnerabilities row 1028 indicates the total number of vulnerabilities within the scope or direction of an individual or subscriber. The total vulnerabilities row 1028 is further broken down into subcategories of complete 1030 and pending 1032. The subcategory complete 1030 indicates the number of vulnerabilities by priority and in total that the organization has neutralized or otherwise addressed. The subcategory pending 1032 indicates the number of vulnerabilities by priority and in total that the organization has not yet neutralized I or addressed. By breaking the vulnerabilities of an organization by individuals or subscribers, vulnerabilities can be tracked according to personnel who are responsible for seeing that such vulnerabilities are addressed. Each section of a report corresponding to a particular individual or subscriber may also include links to lists of the vulnerabilities being tracked or profiles of the products used within the scope or direction of such individual or subscriber. In such a manner, a supervisor or IT manager can easily access, monitor, and track the efforts of individuals within an organization to neutralize or otherwise address vulnerabilities.

Although particular embodiments of the present invention have been described in detail, it should be understood that various changes, substitutions, and alterations can be made to such embodiments without departing from the spirit and scope of the present invention as defined solely by the following claims.

What is claimed is:

1. A method for determining security vulnerabilities, the method comprising:
receiving an organization profile of one or more products used by an organization, the organization profile including characteristics of each of the one or more products;
comparing the characteristics of each of the one or more products to a plurality of product records, each product record identifying one or more security vulnerabilities associated with the product record and one or more fixes associated with the one or more security vulnerabilities; and
determining the presence of at least one of the one or more security vulnerabilities for at least one of the one or more products in response to comparing the characteristics of the at least one of the one or more products to the plurality of product records.

2. The method of claim 1, and further comprising populating the organization profile using a device scanner.

3. The method of claim 1, and further comprising populating the organization profile using a network mapper.

4. The method of claim 1, and further comprising updating the organization profile in response to the determined at least one security vulnerability.

5. The method of claim 1, and further comprising updating the organization profile in response to the determined at least one security vulnerability by supplementing the characteristics of at least one of the one or more products with the identity of the determined at least one security vulnerability.

6. The method of claim 1, and further comprising updating the organization profile in response to the determined at least one security vulnerability by supplementing the characteristics of at least one of the one or more products with a fix associated with the determined at least one security vulnerability.

7. The method of claim 1, and further comprising updating the organization profile in response to the determined at least one security vulnerability by supplementing the characteristics of at least one of the products with a risk rating associated with the determined at least one security vulnerability.

8. The method of claim 1, and further comprising updating the organization profile in response to the determined at least one security vulnerability by supplementing the characteristics of at least one of the products with a determination date associated with the determined at least one security vulnerability.

9. The method of claim 1, wherein determining at least one security vulnerability includes identifying a fix associated with the determined at least one security vulnerability.

10. The method of claim 9, wherein identifying a fix associated with the determined at least one security vulnerability includes discarding a fix already indicated as completed within the organization profile.

11. The method of claim 9, wherein identifying a fix associated with the determined at least one security vulnerability includes discarding a fix that is determined to be unnecessary in response to at least one other product identified by the organization profile as being used by the organization.

12. The method of claim 1, wherein determining at least one security vulnerability includes identifying a security vulnerability in response to more than one product being identified in the organization profile.

13. The method of claim 1, and further comprising determining a risk rating in response the determined at least one security vulnerability.

14. The method of claim 1, wherein determining the at least one security vulnerability further comprises filtering security vulnerabilities included in at least one of the plurality of product records.

15. A system for tracking vulnerabilities in an organization, the system comprising:
an organization profile, the organization profile being associated with a particular organization and identifying one or more products used by the particular organization, the organization profile including characteristics of each of the one or more products;
a security vulnerabilities database, the securities vulnerability database having one or more product records, each of the one or more product records being associated with at least one product and including information on one or more security vulnerabilities associated with the at least one product; and
a search engine in communication with the organization profile and the security vulnerability database, the search engine operable to determine at least one security vulnerability of the organization in response to comparing the characteristics of at least one of the one or more products to at least one of the one or more product records.

16. The system of claim 15, and further comprising a tracking system in communication with the organization profile and operable to track the status of security vulnerabilities across the organization.

17. The system of claim 16, wherein the tracking system includes statistical software operable to calculate statistical data in response to receiving a list of at least one of the one or more products that is associated with a particular individual within the organization and tracking information associated with the at least one product.

18. The system of claim 16, wherein the tracking system includes statistical software operable to update the organization profile with statistical data in response to receiving a list of at least one product associated with a particular individual within the organization and tracking information associated with the listed at least one product.

19. The system of claim 16, wherein the organization profile includes product tracking information operable to be updated by the search engine in response to the at least one security vulnerability being determined, the product tracking information operable to be accessed by the tracking system to track the performance of one or more individuals responsible for addressing the determined at least one security vulnerability within the organization.

20. The system of claim 16, wherein the organization profile includes product tracking information associated with the determined at least one security vulnerability, the product tracking information including a risk rating and a fix.

21. A method of assessing the vulnerability of an organization, the method comprising:
identifying at least one security vulnerability associated with one or more products used by the organization; and
determining a risk rating for the security vulnerability in response to characteristics of the security vulnerability.

22. The method of claim 21, wherein the method further comprises determining the risk rating in response to a simplicity rating of the security vulnerability.

23. The method of claim 21, wherein the method further comprises determining the risk rating in response to a probability rating of the security vulnerability.

24. The method of claim 21, wherein the method further comprises determining the risk rating in response to an impact rating of the security vulnerability.

25. The method of claim 21, wherein the method further comprises determining the risk rating in response to the level of access exposed by the security vulnerability.

26. The method of claim 21, wherein determining the risk rating includes calculating a numerical risk rating.

27. The method of claim 21, wherein determining the risk rating includes calculating a numerical risk rating in response to receiving a numerical simplicity rating, a numerical probability rating, and a numerical impact rating.

28. The method of claim 21, wherein determining the risk rating includes assigning a numerical risk rating in response to calculating an average of a numerical simplicity rating, a numerical probability rating, and a numerical impact rating.

29. The method of claim 21, wherein determining the risk rating includes assigning a numerical risk rating in response to calculating a weighted average of a numerical simplicity rating, a numerical probability rating, and a numerical impact rating.

30. The method of claim 21, and further comprising displaying a graphical representation of the risk rating.

31. A method of tracking security vulnerabilities across an organization, the method comprising:
assigning one or more security vulnerabilities to a particular individual within the organization, each of the one or more assigned security vulnerabilities being associated with one or more products used by the organization;
assigning a pending designation to a status for each of the one or more assigned security vulnerabilities; and
changing the status of one of the one or more security vulnerabilities from a pending designation to a complete designation in response to the one of the one or more security vulnerabilities being addressed by the individual.

32. The method of claim 31, and further comprising assigning a risk rating to each of the assigned one or more security vulnerabilities.

33. The method of claim 31, and further comprising assigning a determination date to each of the assigned one or more security vulnerabilities.

34. The method of claim 31, and further comprising assigning a fix date to at least one of the assigned one or more security vulnerabilities in response to changing the status of the one of the assigned one or more security vulnerabilities from the pending designation to the complete designation.

35. The method of claim 31, and further comprising creating a report for tracking the assigned one or more security vulnerabilities, the report including a designation of the total number of the one or more security vulnerabilities assigned to the individual.

36. The method of claim 31, and further comprising displaying a designation of the total number of the assigned one or more security vulnerabilities associated with each of a plurality of risk ratings.

37. The method of claim 31, and further comprising calculating the total number of pending designations and complete designations associated with the one or more security vulnerabilities assigned to the particular individual.

38. The method of claim 37, wherein calculating the total number of pending designations and complete designations further includes calculating the total number of pending designations and complete designations for each of a plurality of risk ratings.

39. The method of claim 31, and further comprising calculating an average fix delay for the one or more security vulnerabilities assigned to the particular individual in response to a determination date and a fix date associated with each of the assigned one or more security vulnerabilities.

40 The method of claim 31, and further comprising calculating statistical data for an organization in response to combining statistical data for the particular individual with statistical data associated with other individuals within the organization.
